(19) United States
(12) Patent Application Publication
(10) Pub. No.: US 2024/0382930 A1
(43) Pub. Date: Nov. 21, 2024

(54) POLYINDOLE-MONTMORILLONITE COMPLEX AND PREPARATION METHOD AND APPLICATION THEREOF

(71) Applicant: Suzhou University of Science and Technology, Suzhou (CN)

(72) Inventors: Haoting TIAN, Suzhou (CN); Xiaohui YANG, Suzhou (CN)

(73) Assignee: Suzhou University of Science and Technology, Suzhou (CN)

(21) Appl. No.: 18/655,549

(22) Filed: May 6, 2024

(30) Foreign Application Priority Data
May 15, 2023 (CN) 2023105451266

(51) Int. Cl. B01J 20/22; B01J 20/30; C02F 1/28; C02F 1/32; C02F 1/58; C02F 101/36

(52) U.S. Cl. CPC B01J 20/226; B01J 20/3085; C02F 1/285; C02F 1/32; C02F 1/583; C02F 2101/36; C02F 2209/02; C02F 2209/06; C02F 2209/44

(57) ABSTRACT

The present disclosure relates to a polyindole-montmorillonite (Pind-mmt) complex and a preparation method and application thereof. The preparation method includes the following steps: subjecting mmt to cation saturation using ferric chloride, to prepare ferric ion-exchanged montmorillonite (Fe³⁺-mmt); and formulating an indole aqueous solution; adding Fe³⁺-mmt to the indole aqueous solution to enable indole molecules to generate Pind at mmt interlayer by in-situ polymerization, and obtaining a Pind-mmt complex body; and subjecting the Pind-mmt complex body to organic modification with quaternary ammonium salt cationic surfactant to obtain the Pind-mmt complex. The present disclosure discloses a method for generating two-dimensional Pind at mmt interlayer by in-situ polymerization and further discloses a method for using Pind-mmt to efficiently and stably generate hydrated electrons to degrade perfluoroalkyl substances (PFASs) without being affected by dissolved oxygen and pH of water, which is of great significance for coping with PFAS environmental pollution.

### CROSS-REFERENCE TO RELATED APPLICATIONS

The application claims priority to Chinese patent application No. 2023105451266, filed on May 15, 2023, the entire contents of which are incorporated herein by reference.

### TECHNICAL FIELD

The present disclosure relates to a polyindole-montmorillonite (Pind-mmt) complex and a preparation method and application thereof.

### BACKGROUND

Perfluoroalkyl substances (PFASs) are a kind of fluorinated organic compound with important application value, which is widely used in industrial and civil fields due to its oleophobic and hydrophobic properties. Many PFASs are characterized by persistent organic pollutants (POPs) that pose a serious threat to ecosystems and human health. The C—F bond of PFAS molecules is highly polar with a strong bond energy, making it extremely difficult to break. Conventional water treatment technologies are unable to degrade PFASs, highlighting the urgent need to develop efficient methods.

Hydrated electron reduction is an emerging advanced reduction technology in recent years that can effectively degrade PFASs. The oxidation-reduction potential of hydrated electrons (eaq-) is −2.9 V, which presents unique advantages in degrading PFASs, such as high efficiency, universality, and thorough defluorination. However, the hydrated electron reduction has limitations. On one hand, after the generation of hydrated electrons, the properties and structure of the precursor substance change, preventing the further generation of hydrated electrons. As a result, the yield of hydrated electrons is low, leading to significant consumption of the precursor substance. On the other hand, hydrated electrons are highly reactive and easily quenched by O2 and H+ in water, necessitating the control of most reaction systems under anaerobic and alkaline conditions. Therefore, there is a need to explore new reaction mechanisms to overcome the limitations.

### SUMMARY

The present disclosure provides a Pind-mmt complex and a preparation method and application thereof, to solve the above problems of the prior method for degrading PFASs through hydrated electron reduction. In the present disclosure, a Pind-mmt complex with a two-dimensional Pind structure is generated at mmt interlayers by in-situ polymerization, with indole having a strong photo-generated hydrated electron capacity as a precursor, and the reaction of degradation of PFASs by photo-generated hydrated electrons of Pind is performed at mmt interlayers, simultaneously increasing the yield of hydrated electrons and protecting the hydrated electrons from quenching, thereby overcoming the limitations of the hydrated electron reduction and improving the degradation efficiency of PFASs by the hydrated electrons.

The present disclosure provides a preparation method of a Pind-mmt complex, including the following steps:
step (1), subjecting mmt to cation saturation using ferric chloride, to prepare ferric ion-exchanged montmorillonite (Fe3+-mmt); and formulating an indole solution;
step (2), adding Fe3+-mmt to the indole solution to enable indole molecules to generate Pind at mmt interlayer by in-situ polymerization, and obtaining a Pind-mmt complex body; and
step (3), subjecting the obtained Pind-mmt complex body to organic modification with quaternary ammonium salt cationic surfactant to obtain the Pind-mmt complex.

In the above solution, the principle of the present disclosure is that indole can generate Pind by polymerization reaction, with polymerization occurring primarily at positions 2 and 3 without disrupting the indole structure. The inventors have previously found that Pind can continue to generate hydrated electrons under ultraviolet (UV) irradiation and thereby degrade PFASs, but the yield of hydrated electrons and the reaction rate need to be further improved. Compared with three-dimensional structures, materials with two-dimensional structures have obvious advantages in photo-generated carriers, electron migration, and other photochemical properties. By adjusting the size of Pind, a two-dimensional structure is constructed to change the photochemical properties of Pind, which is expected to further improve the yield of hydrated electrons and the degradation efficiency of PFASs. At present, there is no report on the synthesis of two-dimensional Pind. Pind prepared by existing methods is mostly in the form of particles, filaments, rods, and blocks. The sizes are mostly in the micron scale, and the smallest size reported is more than tens of nanometers. mmt is a natural mineral with a crystal layer structure, the crystal plane is naturally negatively charged, there are exchangeable cations between the crystal layers to balance the charge, and the interlayer spacing varies with the different exchangeable cations between the layers, generally between 0.1 to 1.0 nm, which can provide a confined space in chemical reactions. In the present disclosure, the cations at mmt interlayers are completely exchanged into Fe3+, and indole generates Pind at mmt interlayer by in-situ polymerization, with Fe3+ as an oxidant. Pind with a two-dimensional structure is successfully prepared by controlling the growth of Pind in the thickness with the help of the confined space at mmt interlayer, and the Pind-mmt complex body is obtained. Then, the obtained Pind-mmt complex body is subjected to organic modification with the quaternary ammonium salt cationic surfactant to increase its adsorption capacity for organic matters, and the Pind-mmt complex body is obtained. The Pind-mmt complex prepared by the preparation method of the present disclosure is used for photo-generated hydrated electrons to degrade PFASs, and the degradation reaction is performed at mmt interlayers, simultaneously increasing the yield of hydrated electrons and protecting the hydrated electrons from quenching, thus providing a new and effective method for the development of PFAS pollution control technology, and being of great significance for dealing with the problem of PFAS environmental pollution.

Preferably, in step (1), a preparation method of Fe3+-mmt is as follows:
uniformly dispersing sodium ion-saturated mmt into an aqueous solution;
adding ferric chloride solution to the dispersed mmt solution;
stirring before centrifuging and discarding supernatant to obtain precipitation, preferably the process being repeated 3 times; and
washing the obtained precipitation with water and then subjecting to vacuum freeze drying to obtain Fe3+-mmt.

Preferably, the total amount of Fe3+ accounts for 1 to 3 wt % of the total amount of Fe3+-mmt.

By setting the preparation method of Fe3+-mmt, Fe3+ with oxidation effect is stably and appropriately loaded on mmt, thereby facilitating the subsequent in-situ polymerization of indole.

Preferably, in step (1), a formulation method of the indole solution is as follows: adding a solvent to a vessel followed by indole, and then heating to 40° C. before subjecting to ultrasonic dissolution, where the solvent is water, methanol, or acetonitrile; and/or

a concentration of the indole solution is 0.5 to 0.6 g/L, preferably 0.585 g/L.

In the above solution, by specifically designing the formulation method of the indole solution, it is favorable for the formation of a uniform and stable indole solution; by further defining the concentration of the indole solution, it is favorable for the improvement of the efficiency of polymerization reaction of indole.

Preferably, in step (2), a dosage ratio of Fe3+-mmt to the indole solution is (1 to 3) g: (0.1 to 0.3) L.

In the above solution, by limiting the dosage ratio of Fe3+-mmt to the indole solution in step (2) to a reasonable range of values, it is advantageous to control the growth of Pind on the thickness of Fe3+-mmt to prepare Pind with a specific two-dimensional structure, and a Pind-mmt complex body with excellent performance is obtained, which is further advantageous to improve the yield of hydrated electrons of Pind.

Preferably, the in-situ polymerization is performed at a shaking speed of 200 to 250 r/min for 10 to 14 h, preferably at a shaking speed of 220 r/min for 12 h.

In the above solution, by reasonably defining the shaking speed and time during the in-situ polymerization, it is favorable for the improvement of the efficiency of the in-situ polymerization.

Preferably, step (3) is specifically as follows: dispersing 1 part by weight of the obtained Pind-mmt complex body into 5 to 15 parts by weight of aqueous solution, then adding 15 to 40 parts by weight of quaternary ammonium salt cationic surfactant solution; stirring before centrifuging and discarding supernatant to obtain the precipitation; and washing the obtained precipitation to prepare an organically modified Pind-mmt complex. Preferably, 1 part by weight of the obtained Pind-mmt complex body is dispersed into 10 parts by weight of aqueous solution, and 15 to 40 parts by weight of the quaternary ammonium salt cationic surfactant solution is added before stirring.

In the above solution, by reasonably defining the dosage ratio of each raw material in the modification process, it is more favorable for the organic modification of the Pind-mmt complex body to increase its adsorption capacity for organic matters, and then it is more favorable for the adsorption of PFASs into the interlayers of the Pind-mmt complex body so that the reaction of the degradation of PFASs by hydrated electrons is performed in the interlayers and the degradation efficiency is improved.

Preferably, a concentration of the quaternary ammonium salt cationic surfactant solution is 5 to 6 g/L, preferably 5.472 g/L; preferably, the quaternary ammonium salt cationic surfactant is hexadecyl trimethyl ammonium chloride.

In the above solution, by defining the concentration of the quaternary ammonium salt cationic surfactant solution and the type of the quaternary ammonium salt cationic surfactant, it is more favorable for the organic modification of the Pind-mmt complex body to increase its adsorption capacity for organic matters.

The present disclosure further provides a Pind-mmt complex obtained by the above preparation method.

Preferably, application of the Pind-mmt complex in degradation of PFASs is provided.

The present disclosure further provides the above application, including the following steps:
formulating a PFAS aqueous solution;
dispersing the Pind-mmt complex in the formulated PFAS aqueous solution, adjusting a pH to 5.0 to 7.0, and then stirring uniformly to obtain a mixture; and
transferring the obtained mixture to a reactor, and then immersing a low-pressure mercury lamp into the mixture, and turning on the lamp to perform a degradation reaction.

In the above solution, the present disclosure applies the Pind-mmt complex to the degradation process of PFASs, and Pind-mmt adsorbs PFASs into the interlayer by adsorption effects, so that the reaction of the degradation of PFASs by hydrated electrons is performed in the interlayer. Due to the existence of the interlayer confinement effect, the mass transfer of oxygen and hydrogen ions in the water into the interlayer can be effectively inhibited, the hydrated electrons generated in the interlayer are protected from quenching, and the reaction is not affected by the dissolved oxygen and pH of the water, which greatly extends the application range of the method. The inventors have also observed that dissolved oxygen and hydrogen ions in the solution have little effect on the degradation reaction. Since hydrated electrons can be rapidly quenched by oxygen and hydrogen ions, the reduction reaction of hydrated electrons to degrade contaminants needs to be controlled under anaerobic and alkaline conditions. The inventors perform repeated experiments using the above degradation method, and the reuse experiments show that Pind-mmt has good sustainable utilization, significantly reducing material consumption. Pind-mmt also has a good settle ability, and after the stirring is stopped at the end of the reaction, Pind-mmt quickly settles to the bottom of the reactor, and the reaction solution becomes clear, which provides convenience for the reaction process design.

Preferably, a system of the degradation reaction is an open system without air isolation; and/or
the degradation reaction is performed at 25±1° C. for 1 to 6 h, with alight source being a 36W low-pressure mercury lamp, an emerging light wavelength therefrom being mainly concentrated at 254 nm; and/or
contents of the Pind-mmt complex and the PFASs in the mixture are 0.5 to 1.5 g/L and 5 to 10 mg/L, respectively, and water for the reaction is ultrapure water; preferably, the contents of the Pind-mmt complex and the PFASs in the mixture are 1.0 g/L and 10 mg/L, respectively.

In the above solution, by reasonably and effectively designing the system conditions, temperature, time, type of light source, and the contents of the Pind-mmt complex and the PFASs during the degradation reaction, it is favorable for the improvement of the degradation reaction efficiency.

The beneficial effects are as follows:

The preparation method of Pind-mmt complex according to the present disclosure aims at the limitation of the degradation of PFASs by hydrated electrons. Pind is generated at mmt interlayers by in-situ polymerization, with indole having a strong photo-generated hydrated electron capacity as a precursor. Pind with a two-dimensional structure is acquired by controlling the growth of Pind in the thickness with the help of the confined space of mmt. The upper limit of the yield of hydrated electrons of monomolecular indole is broken, and a new material for continuously and efficiently generating hydrated electrons is obtained.

By applying the Pind-mmt complex of the present disclosure to the degradation of PFASs, the reaction of degradation of PFASs by photo-generated hydrated electrons of Pind is performed at mmt interlayers, simultaneously increasing the yield of hydrated electrons, and protecting the hydrated electrons from quenching, thus providing a new technical method for effectively degrading PFASs using hydrated electrons.

### BRIEF DESCRIPTION OF DRAWINGS

FIG. 1 is a diagram of polymerization of indole at mmt interlayers to generate Pind according to the present disclosure;

FIG. 2 is an infrared (IR) spectrogram of Pind-mmt, Pind, mmt obtained in Example 1 according to the present disclosure;

FIG. 3 is a graph of X-ray diffraction (XRD) phenogram of Na+-mmt, Fe3+-mmt, and Pind-mmt in an experimental example according to the present disclosure;

FIG. 4 is an electron paramagnetic resonance (EPR) spectrum of samples subjected to UV irradiation alone, UV irradiation with Pind added, and UV irradiation with Pind-mmt added in an experimental example according to the present disclosure;

FIG. 5 is a diagram of reaction mechanisms of degradation of perfluorooctanoic acid (PFOA) by hydrated electrons generated by Pind-mmt under UV irradiation according to the present disclosure;

FIG. 6 are comparison graphs of degradation rate and defluorination rate of PFOA with UV irradiation alone, with Pind added, and with Pind-mmt added according to the present disclosure;

FIG. 7 are graphs of degradation rate and defluorination rate for a reuse experiment of degradation of PFOA by Pind-mmt according to the present disclosure;

FIG. 8 are comparison graphs of degradation of PFOA by Pind-mmt under aerobic and anaerobic conditions according to the present disclosure; and

FIG. 9 are comparison graphs of degradation of PFOA by Pind-mmt under different pH conditions according to the present disclosure.

### DETAILED DESCRIPTION OF THE EMBODIMENTS

### Example 1

The example provides a preparation method of a Pind-mmt complex, including the following steps:

At step (1), the sodium ion-saturated mmt was uniformly dispersed into an aqueous solution; 0.1 mol/L ferric chloride solution was added to the dispersed mmt solution, followed by stirring before centrifuging, discarding supernatant to obtain precipitation, with this process being repeated 3 times; the obtained precipitation was washed with water and then is subjected to vacuum freeze drying to obtain Fe3+-mmt, where the total amount of Fe3+ accounts for 1 to 3 wt % of the total amount of Fe3+-mmt.

0.2 L of pure water was added to a vessel followed by 117 mg of indole, and then heated to 40° C. before subjecting to ultrasonic dissolution, to obtain an indole aqueous solution with a concentration of 0.585 g/L.

At step (2), 2 g of Fe3+-mmt was weighed into 0.5 mM of formulated indole aqueous solution, and then placed in a shaker at 220 rpm for 12 h. Subsequently, the samples were centrifuged and the supernatant was discarded, and the impurities were repeatedly washed with pure water to prepare a Pind-mmt complex body.

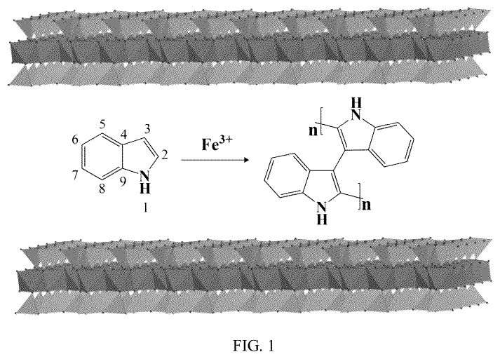

At step (3), 1 g of prepared Pind-mmt complex body was re-dispersed into 10 g of aqueous solution, then 30 g of hexadecyl trimethyl ammonium chloride solution with a concentration of 5.472 g/L was quickly added and stirred vigorously for 10 min; after the end of the stirring, the samples were placed in a shaker to shake at 220 rpm for 12 h before centrifuging to discard the supernatant to obtain precipitation; the obtained precipitation was washed with pure water to obtain a lightly organically modified Pind-mmt complex, ready for use. The diagram of the polymerization of indole at mmt interlayers to generate Pind is shown in FIG. 1.

### Experimental Example

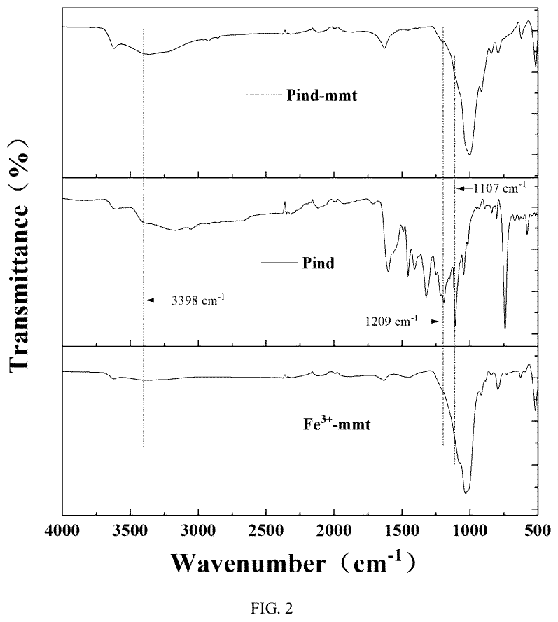

The Pind-mmt sample obtained in Example 1 was characterized by IR spectroscopy, and the obtained IR spectrogram is shown in FIG. 2. Since Pind-mmt is an intercalation complex of Pind and mmt, theoretically, the IR spectrum of Pind-mmt is a composite superposition spectrum of Pind and mmt. Since the main structure of Pind-mmt is mmt, it can be seen from the IR spectrum that the IR characteristic absorption peak of Pind in Pind-mmt is mostly covered by the IR characteristic absorption peak of mmt. However, compared with the IR spectrum of Pind synthesized by conventional method, it was found that Pind-mmt still had IR characteristic absorption peaks of Pind at 3398 cm-1, 1209 cm-1, and 1107 cm-1, in which 3398 cm-1 represented the stretching vibration of N—H bond, and 1209 cm-1 and 1107 cm-1 represented the stretching vibration of benzene ring of Pind, which proved that Pind was successfully synthesized at mmt interlayers.

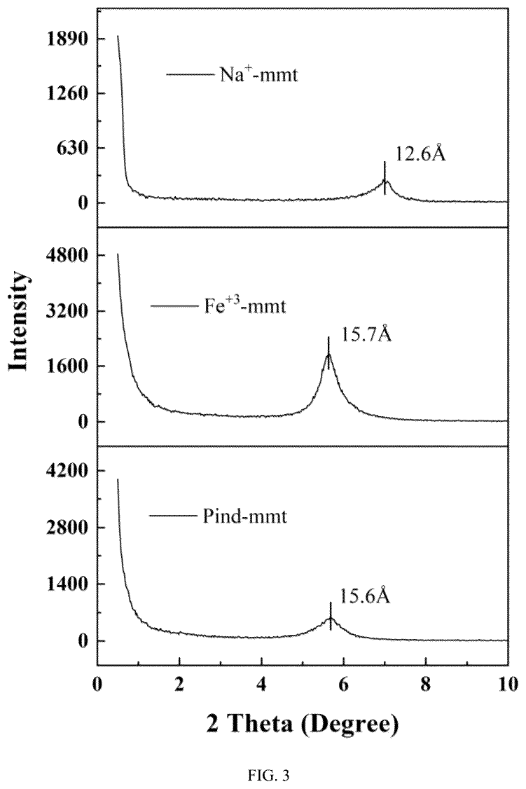

An XRD characterization was performed on the Pind-mmt sample obtained in Example 1, and the XRD spectrum is shown in FIG. 3, with a Na+-mmt interplanar spacing of about 12.6 Å, a Fe3+-mmt interplanar spacing of about 15.7 Å, and a Pind-mmt interplanar spacing of about 15.6 Å. Typically, the thickness of the mmt wafer is about 10 Å, from which it is calculated that the interlayer spacings between Na+-mmt, Fe3+-mmt, and Pind-mmt wafers are about 2.6 Å, 5.7 Å, and 5.6 Å, that is, 0.26 nm, 0.57 nm, and 0.56 nm, respectively. The results show that the generation of Pind at Fe3+-mmt interlayer by in-situ polymerization does not enlarge the interlayer spacing, and the growth of Pind in the thickness is well controlled. Since indole is a planar structure, its thickness is about 0.2 nm. Pind is generated by the polymerization of indole, and the monolayer thickness of Pind should be greater than 0.2 nm. It can be seen from the Pind-mmt interlayer spacing of 0.56 nm that the thickness of Pind at mmt interlayers by in-situ polymerization is less than 0.56 nm, which is a two-dimensional structure, even a monolayer structure.

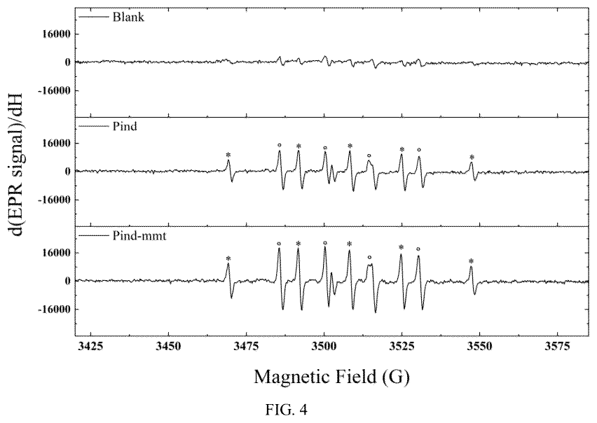

The determination of Pind-mmt hydrated electrons is as follows: Pind-mmt was first dispersed in an aqueous solution, then transferred to a 15 mL cylindrical quartz reaction tube, the pH of the solution was adjusted to 6.0 using 0.1 mol/L NaOH and HCl, and the hydrated electron capturer 5,5-dimethyl-1-pyrroline-N-oxide (DMPO) was added. The total reaction volume was 10 mL with contents of Pind-mmt and DMPO being 2.0 g/L and 100 mM, respectively. After irradiating the prepared samples with the mercury lamp for 1.5 min, 25 μL of the samples were sampled with a quartz capillary and placed in the resonant cavity of an EPR instrument to detect the signals of the free radicals. It was found from the experimental results (FIG. 4) that only small amounts of signals of the free radicals could be detected in the system without the addition of Pind-mmt. After the addition of Pind-mmt, in addition to the signals of hydroxyl radicals, strong signals of hydrated electrons were also detected in the samples, which proved that Pind-mmt could generate hydrated electrons under UV irradiation. From the point of view of the signal strength of hydrated electrons, hydrated electrons produced by Pind-mmt are significantly higher than those produced by Pind. The Pind used in the experiments was synthesized by conventional methods and had a three-dimensional structure with sizes in the micron scale. The Pind in Pind-mmt has a thickness of less than 0.56 nm with a two-dimensional structure, indicating that the two-dimensional structure could significantly improve the yield of hydrated electrons of Pind. The circles in the drawings indicated the EPR signals of hydroxyl radicals, and the asterisks indicated the EPR signals of hydrated electrons.

### Example 2

The example provides application of the Pind-mmt complex obtained in Example 1 in degradation of PFASs, and the application includes the following steps:

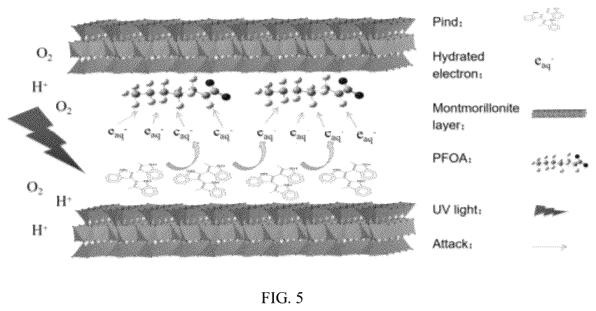

Before the degradation reaction, 10 mg/L PFOA aqueous solution was firstly formulated, then Pind-mmt was dispersed in PFOA solution and 0.1 mol/L NaOH and HCl were used to adjust the pH of the solution to 6.0; the formulated mixture was stirred for 0.5 h through magnetic stirring before transferring into a cylindrical quartz glass reactor; in an open environment, a low-pressure mercury lamp was immersed into the mixture, turning on the lamp to perform a degradation reaction. The reaction volume was 200 mL, and the reaction was performed at 25±1° C. for 6 h, with a light source being a 36W low-pressure mercury lamp (the emerging light wavelength therefrom was mainly concentrated at 254 nm). The contents of Pind-mmt and PFOA in the mixture were 1 g/L and 10 mg/L, respectively. 2 mL of samples were collected every 1 hour, and the samples were divided into two parts. For one of the parts, the remaining PFOA content was detected by high performance liquid chromatography-tandem mass spectrometry (HPLC-MS/MS) after extraction with twice the volume of methanol, and the degradation rate of PFOA was calculated. The other part was added with twice the volume of pure water, and filtered with 0.22 μm water phase filter membrane after swirling and shaking for 1 min, and then measured the generated F ion content by ion chromatography (IC), to calculate the defluorination rate of PFOA. The diagram of reaction mechanisms of degradation of PFOA by hydrated electrons generated by Pind-mmt under UV irradiation according to the present disclosure is shown in FIG. 5.

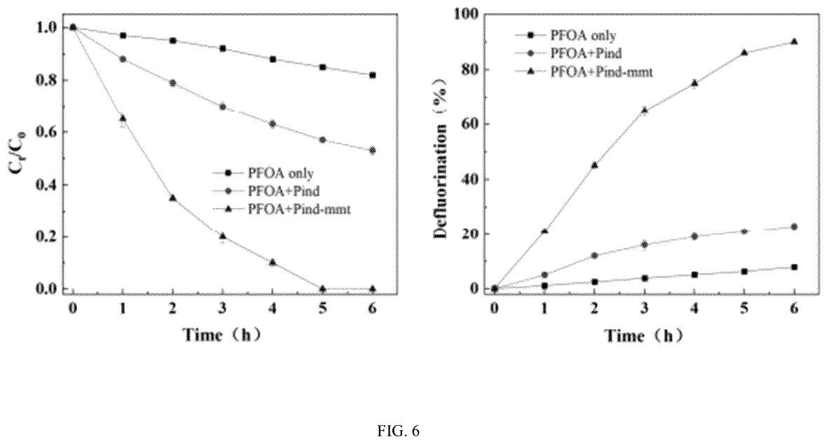

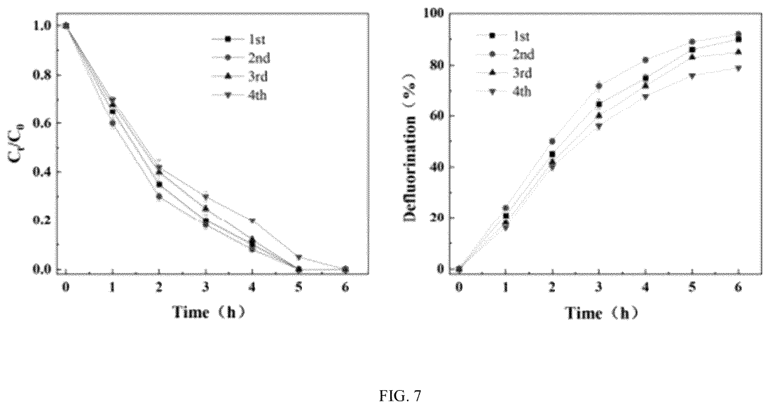

The present disclosure investigated the effects of UV irradiation alone, with Pind added, or with Pind-mmt added on the degradation rate and defluorination rate of PFOA. The experimental results in FIG. 6 show that UV irradiation alone has lower degradation and defluorination rates of PFOA. With Pind or Pind-mmt added, the degradation rate and defluorination rate of PFOA increased significantly. Comparing the groups with Pind and Pind-mmt added, the degradation rate and defluorination rate of PFOA by Pind-mmt were significantly higher than those by Pind. After 6 hours of reaction, the defluorination rate of PFOA by Pind-mmt could reach 88%. The present disclosure performs a reusable experiment on Pind-mmt. As shown in FIG. 7, four repeated experiments showed that the defluorination rate of Pind-mmt for PFOA did not decrease significantly, and the defluorination rate could reach more than 75% after the fourth reaction. According to previous studies, there are 15 carbon-fluorine bonds in the PFOA molecule, and it is conservatively estimated that about 50% of the carbon-fluorine bond breakage is caused by the direct attack of hydrated electrons. The amount of PFOA used in the experiments of the present disclosure was 10 mg/L. After accounting for four repeated experiments, the yield of hydrated electrons of indole units in Pind-mmt reached 900%, that is, each indole unit produced at least 9 hydrated electrons. After one hydrated electron is produced from one indole molecule, the structure of the indole molecule changes itself, and it is difficult to produce the hydrated electron again, so the yield of hydrated electrons generally does not exceed 100%. Therefore, the two-dimensional Pind in Pind-mmt breaks through the upper limit of the yield of hydrated electrons of monomolecular indole and has the ability of continuously and stably producing hydrated electrons.

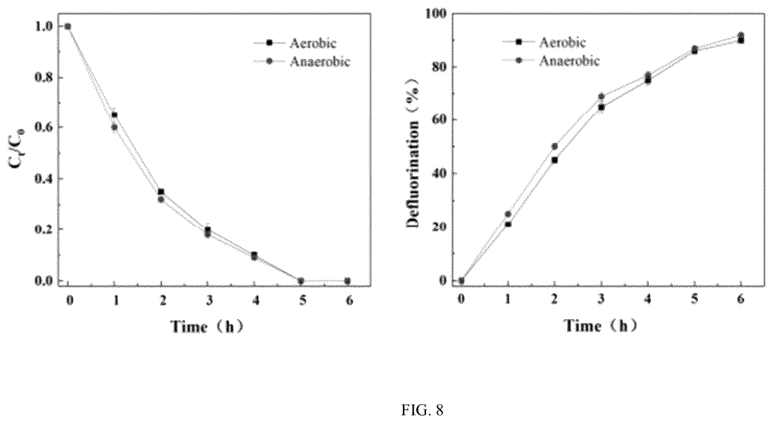

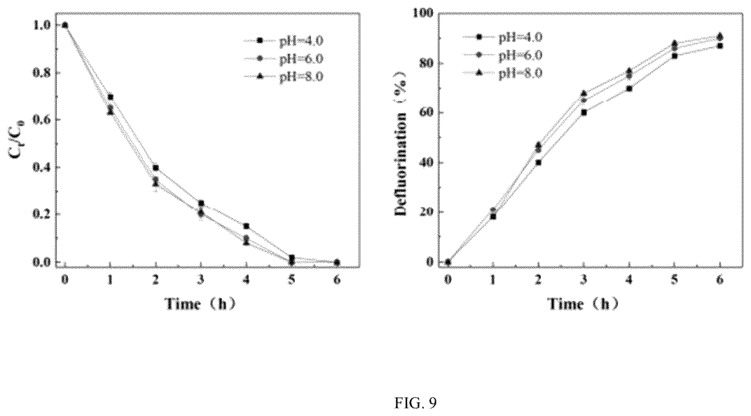

The present disclosure further investigated the effects of dissolved oxygen and pH on the degradation of PFOA by photo-generated hydrated electrons of Pind-mmt. The degradation and defluorination effects of Pind-mmt on PFOA under anaerobic and aerobic conditions were compared. As shown in FIG. 8, the degradation rate and defluorination rate of PFOA under aerobic conditions were slightly lower than those under anaerobic conditions, but the decrease was not obvious. The present disclosure still further investigated the effect of pH on the reaction. As shown in FIG. 9, the defluorination rate of PFOA by Pind-mmt under aerobic conditions was hardly affected by the pH of the solution. Therefore, Pind-mmt inherits the confined space effect of mmt, which can hinder the mass transfer of O2 and H+ into its interlayers and simultaneously protect hydrated electrons from quenching.

What is claimed is:

1. A preparation method of a polyindole-montmorillonite (Pind-mmt) complex, comprising the following steps:
step (1), subjecting mmt to cation saturation using ferric chloride, to prepare ferric ion-exchanged montmorillonite (Fe³⁺-mmt); and formulating an indole solution;
step (2), adding Fe³⁺-mmt to the indole solution to enable indole molecules to generate Pind at mmt interlayer by in-situ polymerization, and obtaining a Pind-mmt complex body; and
step (3), subjecting the obtained Pind-mmt complex body to organic modification with quaternary ammonium salt cationic surfactant to obtain the Pind-mmt complex.

2. The preparation method according to claim 1, wherein in step (1), a preparation method of Fe³⁺-mmt is as follows:
uniformly dispersing sodium ion-saturated mmt into an aqueous solution;
adding ferric chloride solution to the dispersed mmt solution;
stirring before centrifuging and discarding supernatant to obtain precipitation; and
washing the obtained precipitation with water and then subjecting to vacuum freeze drying to obtain Fe³⁺-mmt.

3. The preparation method according to claim 1, wherein the total amount of Fe³⁺ accounts for 1 to 3 wt % of the total amount of Fe³⁺-mmt.

4. The preparation method according to claim 1, wherein in step (1), a formulation method of the indole solution is as follows: adding a solvent to a vessel followed by indole, and then heating to 40° C. before subjecting to ultrasonic dissolution, wherein the solvent is water, methanol, or acetonitrile; and/or
a concentration of the indole solution is 0.5 to 0.6 g/L, preferably 0.585 g/L.

5. The preparation method according to claim 1, wherein in step (2), a dosage ratio of Fe³⁺-mmt to the indole solution is (1 to 3) g: (0.1 to 0.3) L; and/or
the in-situ polymerization is performed at a shaking speed of 200 to 250 r/min for 10 to 14 h, preferably at a shaking speed of 220 r/min for 12 h.

6. The preparation method according to claim 5, wherein step (3) is specifically as follows: dispersing 1 part by weight of the obtained Pind-mmt complex body into 5 to 15 parts by weight of aqueous solution, then adding 15 to 40 parts by weight of quaternary ammonium salt cationic surfactant solution; stirring before centrifuging and discarding supernatant to obtain the precipitation; and washing the obtained precipitation to prepare an organically modified Pind-mmt complex; and
preferably, a concentration of the quaternary ammonium salt cationic surfactant solution is 5 to 6 g/L; and/or the quaternary ammonium salt cationic surfactant is hexadecyl trimethyl ammonium chloride.

7. A polyindole-montmorillonite (Pind-mmt) complex, obtained by the preparation method according to claim 1.

8. Application of the Pind-mmt complex according to claim 7 in degradation of perfluoroalkyl substances (PFASs).

9. The application according to claim 8, wherein the application comprises the following steps:
formulating a PFAS aqueous solution;
dispersing the Pind-mmt complex in the formulated PFAS aqueous solution, adjusting a pH to 5.0 to 7.0, and then stirring uniformly to obtain a mixture; and
transferring the obtained mixture to a reactor, and then immersing a low-pressure mercury lamp into the mixture, and turning on the lamp to perform a degradation reaction.

10. The application according to claim 9, wherein a system of the degradation reaction is an open system without air isolation; and/or
the degradation reaction is performed at 25±1° C. for 1 to 6 h, with a light source being a 36W low-pressure mercury lamp, an emerging light wavelength therefrom being mainly concentrated at 254 nm; and/or
contents of the Pind-mmt complex and the PFASs in the mixture are 0.5 to 1.5 g/L and 5 to 15 mg/L, respectively, and water for the reaction is ultrapure water; preferably, the contents of the Pind-mmt complex and the PFASs in the mixture are 1.0 g/L and 10 mg/L, respectively.
